(19) United States
(12) Patent Application Publication
(10) Pub. No.: US 2022/0380706 A1
(43) Pub. Date: Dec. 1, 2022

(54) LAUNDRY DETERGENT ARTICLE

(71) Applicant: Church & Dwight Co., Inc., Princeton, NJ (US)

(72) Inventors: Leilani Pechera, Kendall Park, NJ (US); Andre Gomes, Jackson, NJ (US); John F. Poccia, III, Monmouth Beach, NJ (US); Steven T. Adamy, Lawrenceville, NJ (US); Adam E. Butera, Fairless Hills, PA (US)

(73) Assignee: Church & Dwight Co., Inc., Princeton, NJ (US)

(21) Appl. No.: 17/751,459

(22) Filed: May 23, 2022

Related U.S. Application Data
(60) Provisional application No. 63/192,474, filed on May 24, 2021.

(51) Int. Cl. C11D 17/04; C11D 17/06; C11D 3/37

(52) U.S. Cl. CPC C11D 17/044; C11D 17/06; C11D 3/3707

(57) ABSTRACT

An article is provided that comprise a solid detergent formulation provided within a fabric pouch. The detergent can be formed of a typical detergent that is combined with a polymer granulation aid to provide the detergent as a formulation comprising a plurality of particles. The fabric pouch can be water-soluble and can particularly be formed of fibers (e.g., woven or non-woven) that are water soluble. The fabric pouch can have a plurality of pores that provide for rapid infiltration of water for dissolution of the detergent therein and the pouch itself while still avoiding any significant loss of the detergent therefrom prior to use in washing. A method of forming a detergent formulation is also provided.

### CROSS-REFERENCE TO RELATED APPLICATIONS

The present application claims priority to U.S. Provisional Patent Application No. 63/192,474, filed May 24, 2021, the disclosure of which is incorporated herein by reference in its entirety.

### FIELD OF THE DISCLOSURE

The present disclosure relates to detergent formulations and articles for unit dose provision of the detergent formulations with improved dissolution properties, particularly for automatic laundry machines. The articles can comprise a detergent formulation that is contained within a porous pouch material, such as a pouch formed of a woven or nonwoven fabric that is made of water-soluble fibers.

### BACKGROUND

The use of water-soluble film packages to deliver unit dosage amounts of laundry products is known, and detergents and bleaches have been sold in this form for many years. A compact granular detergent composition in a water-soluble film pouch has been described in Japanese Patent Application No. 61-151032, filed Jun. 27, 1986, which is incorporated herein by reference. A paste detergent composition packaged in a water-soluble film is disclosed in Japanese Patent Application No. 61-151029, also filed Jun. 27, 1986. Further disclosures relating to detergent compositions which are either pastes, gels, slurries, or mulls packaged in water-soluble films can be found in U.S. Pat. No. 8,669,220 to Huber et al.; U.S. Pat. App. Pub. Nos. 2002/0033004 to Edwards et al., 2007/0157572 to Oehms et al., and 2012/0097193 to Rossetto et al.; Canadian Patent No. 1,112,534 issued Nov. 17, 1981; and European Patent Application Nos. 158464 published Oct. 16, 1985 and 234867, published Sep. 2, 1987; each of which is incorporated herein by reference. A liquid laundry detergent containing detergents in a water/propylene glycol solution is disclosed in U.S. Pat. No. 4,973,416, which is herein incorporated by reference. See, also, U.S. Pat. No. 7,915,213 to Adamy et al. and U.S. Pat. App. Pub. No. 2006/0281658 to Kellar et al., which disclose compositions with high builder content for use in pods, the disclosures of said documents being incorporated herein by reference. Known unit dose detergent articles can suffer from poor dissolution of the pouch or other carrier material, and this can exacerbate poor dissolution properties of detergents retained by the pouch or other carrier. This can result in wash cycles where a substantially undissolved pod remains in the wash load or when residue is present due to solids that were released from the article but not fully dissolved. There is still a desire and a need to provide laundry detergent compositions that are in unit dose forms. There is also a desire and need for unit does laundry compositions and articles that achieve improved solubility in automatic laundry machines.

### SUMMARY OF THE DISCLOSURE

The present disclosure relates to detergent articles. The article is provided as unit dose articles in that the article is intended to provide a sufficient quantity of detergent for carrying out laundering of a typical load in standard washing machines. The articles comprise a detergent included within a pouch to provide the unit dose. The pouch can be specifically configured as a fabric—i.e., woven fabric or nonwoven fabric. The fabric is formed of water soluble fibers and particularly polymer fibers that are water soluble. The fabric this includes pores that provide for improved infiltration of water for dissolution of the detergent therein and the pouch itself. The detergent comprises a typical detergent (e.g., solid or liquid laundry detergent comprising a surfactant, builder, and optionally other components typically found in laundry detergents). The detergent is combined with a granulating aid that provides form formulating the detergent as a plurality of solid particles that are sized specifically to be contained within the fabric pouch without significant leakage through the pores of the fabric. The granulating aid can provide further advantages, such as improving dissolution of the detergent an even providing additive cleaning efficacy.

In one or more embodiments, the present disclosure thus can provide an article comprising: a solid formulation that is a blend of a polymer granulation aid and a detergent composition comprising at least a surfactant and a builder, the polymer granulation aid comprising at least about 20% by weight of the solid formulation based on the total weight of the solid formulation; and a pouch enclosing the solid formulation, the pouch being configured as a woven or nonwoven fabric formed of water-soluble fibers. In further embodiments, the article can be defined in relation to one or more of the following statements, which statements can be combined in any number or order.

The polymer granulation aid can be a melt-reversible polymer.

The polymer granulation aid can have a melting temperature of about 40° C. to about 80° C.

The polymer granulation aid can be a polyethylene glycol (PEG) material.

The PEG material can have an average molecular weight of about 1000 Da to about 25000 Da.

The polymer granulation aid can be an ethylene oxide (EO) propylene oxide (PO) copolymer.

The solid formulation can be in the form of a plurality of particles.

The plurality of particles can have an average particle size of about 80 microns or greater.

The solid formulation can be configured as a plurality of particles having an average particle size, wherein the woven or nonwoven fabric can be configured to have a plurality of pores defining an average pore size, and wherein a ratio of the average particle size to the average pore size can be about 1.6 or greater.

The average particle size to the average pore size can be no more than 50.

The ratio of the average particle size to the average pore size can be about 6 to about 35.

The water-soluble fibers can include fibers selected from the group consisting of polyvinyl alcohol (PVOH), polyethylene oxide, methyl cellulose, polyacrylates, and mixtures thereof.

The pouch can be configured to have an air permeability of about 10 ft³/ft²/min.

The pouch can be configured to have an average pore size of about 350 microns or less.

The pouch can be configured to have an average pore size of at least 5 microns.

The pouch can be configured to have an average pore size of about 50 microns to about 350 microns.

The pouch can be configured to have a basis weight of about 5 gsm (grams per square meter) to about 150 gsm.

In some embodiments, the present disclosure can relate to an article comprising: a plurality of particles of a formulation that comprises a detergent composition combined with a melt-reversible polymer, the detergent composition comprising at least a surfactant and a builder, and the melt-reversible polymer comprising at least about 20% by weight of the formulation based on the total weight of the solid formulation; and a pouch enclosing the plurality of particles, the pouch being configured as one or more sheets of a water-soluble polymer in a non-film configuration. In further embodiments, the article can be defined in relation to one or more of the following statements, which statements can be combined in any number or order.

The melt-reversible polymer can have a melting temperature of about 40° C. to about 80° C.

The melt-reversible polymer can comprise one or more of a polyethylene glycol (PEG) material and an ethylene oxide (EO) propylene oxide (PO) copolymer.

The plurality of particles can have an average particle size that is greater than about 80 microns.

The one or more sheets of the water-soluble polymer can be configured as a woven or nonwoven fabric formed of water-soluble fibers.

The pouch can be formed of a material selected from the group consisting of polyvinyl alcohol (PVOH), polyethylene oxide, methyl cellulose, polyacrylates, and mixtures thereof.

In further embodiments, the present disclosure can relate to methods of forming or preparing a detergent formulation. For example, such method can comprise: mixing a detergent composition comprising at least a surfactant and a builder with a melt-reversible polymer while the melt-reversible polymer is in a flowable condition to form a blend of the detergent composition and the melt-reversible polymer; solidifying the formed blend; and processing the formed blend through a granulator to configure the formed blend as a plurality of particles.

### BRIEF DESCRIPTION OF THE DRAWINGS

Having thus described aspects of the disclosure in the foregoing general terms, reference will now be made to the accompanying drawings, which are not necessarily drawn to scale. The drawings are examples only, and should not be construed as limiting the disclosure.

FIG. 1 illustrates example unit dose laundry detergent articles according to embodiments of the present disclosure.

FIG. 2 are photos illustrating a water-soluble polyvinyl alcohol (PVOH) fabric pouch (left) and a water-soluble PVOH film pouch (right) containing the same granules.

FIG. 3 is a photo illustrating a water-soluble PVOH fabric pouch inside a water-insoluble fabric for residue testing.

FIG. 4. is a photo illustrating laundry detergent tablets consisting of the combination of liquid laundry detergent, polymer and an additional ingredient.

FIG. 5 is a photo illustrating laundry detergent tablets enclosed with heat-sealed fabric PVOH.

FIG. 6 a water-soluble PVOH fabric pouch (left) and a water-soluble PVOH film pouch (right) containing the same tablets.

### DETAILED DESCRIPTION OF THE DISCLOSURE

The present disclosure now will be described more fully hereinafter with reference to the accompanying drawings. The disclosure may be embodied in many different forms and should not be construed as limited to the embodiments set forth herein; rather, these embodiments are provided so that this disclosure will satisfy applicable legal requirements. Like numbers refer to like elements throughout. As used in this specification and the claims, the singular forms “a,” “an,” and “the” include plural references unless the context clearly dictates otherwise.

In one or more embodiments, the present disclosure provides laundry detergent articles. Such articles can comprise a package enclosing a detergent formulation. The article can be configured so that the detergent formulation is in direct contact with the package (or generally retained by the package) and such that the laundry detergent is released from the package when placed in water. The articles of the present disclosure are particularly configured so that water will rapidly infiltrate the package to begin the process of dissolution of the laundry detergent formulation in the water. The articles also are configured so that the package itself rapidly dissolves in the water along with the laundry detergent.

As used herein, terms such as “package”, “pod”, “pouch”, and the like can be used interchangeably to describe the water-soluble material enclosing laundry detergents described herein. According to the disclosure, the water-soluble material is in substantially direct contact with the laundry detergent, with the water soluble material maintaining its structural integrity prior to external contact with an aqueous medium, such as a laundry wash liquor. The detergent is configured for storage stability, such as over a relatively wide temperature range, such as might be encountered in storage, and the pouch retains is properties of rapid dissolution in water even after extended storage. In addition, the detergent formulation is in a form such that a significant content of the detergent does not escape or leak from the pouch enclosing the detergent prior to dissolution of the pouch material during use.

The articles described herein can be provided in a variety of shapes and sizes. For example, in a cross-section through the horizontal dimension, the articles can be substantially in the form of a square, rectangle, parallelogram, triangle, circle, or other shape. In various embodiments, the articles described herein can have a length of up to about 10 cm, up to about 8 cm, or up to about 6 cm, with the minimum length being at least 1 cm, at least 2 cm, at least 3 cm, or at least 4 cm. In particular, the length can be about 5 cm to about 10 cm (e.g., about 6.5 cm). The articles likewise can have a width of up to about 10 cm, up to about 8 cm, or up to about 6 cm, with the minimum width being at least 1 cm, at least 2 cm, at least 3 cm, or at least 4 cm. In particular, the width can be about 5 cm to about 10 cm (e.g., about 5.8 cm). The articles can have a thickness of up to about 4 cm, up to about 3 cm, or up to about cm, with a minimum thickness of at least 0.2 cm, 0.3 cm, 0.4 cm, or 0.5 cm. In particular, the articles can have a thickness of about 0.2 to about 2 cm (e.g., about 0.4 cm). The pouches, in some embodiments, can particularly be provided with a thickness that is less than both of the length and width. For example, a ratio of length to thickness and a ratio of width to thickness can each independently be at least about 5:1, at least about 7:1, at least about 10:1, at least about 12:1, or at least about 14:1, and the minimum ratio can be about 2:1, about 3:1, or about 4:1. In certain embodiments, the ratio can be about 2:1 to about 25:1, about 3:1 to about 20:1, about 4:1 to about 18:1, or about 5:1 to about 16:1. In some embodiments, the ratio can be about 10:1 to about 25:1, about 12:1 to about 20:1, or about 13:1 to about 18:1. Such dimensions are specifically chosen to provide improved dissolution properties of the articles that arise from the combination of the pouch configuration and the detergent formulation that is retained within the pouch. The dimensions likewise can be balanced with the weight of the detergent enclosed therein in order to provide fast and complete dissolution of the pouch and detergent in the wash water in a manner that is not otherwise attainable with known laundry detergent articles.

Pouch Material

The pouch material used in forming the present articles is a water-soluble material that is provided in a non-film configuration. A “non-film” configuration indicates that the material is not a continuous an uninterrupted sheet of material as would be present in a film or sheet that is used in many known laundry detergent pods. A non-film configuration rather indicates that the material includes a plurality of pores or other discontinuities formed therein so that the interior space of the pouch is in direct communication with the surrounding atmosphere. In some embodiments, a non-film pouch material can be configured as a sheet that includes a plurality of pores or other openings therein that extend fully from the outer surface of the sheet to the inner surface of the sheet. In some embodiments, a non-film pouch can be configured as a textile material in that it is formed from a plurality of distinct fibers that are combined to form a fabric. As such, the pouch can be formed of a water soluble, porous sheet or can be formed of a water-soluble fabric. While known unit dose laundry detergent articles are conventionally formed of an encapsulating film material, the present disclosure provides articles wherein the pouch exhibits a unique appearance and feel in combination with improved properties and functionalities as otherwise described herein. Results of consumer research have indicated that consumers positively receive a fabric-like texture for a unit dose laundry detergent article. This can be at least in part due to a perception that a fabric-textured unit dose laundry detergent article may be more gentle than conventional film-encapsulated unit dose pods with regard to use in cleaning clothes.

As used herein, the term “fabric” refers to a cloth, sheet, or other material structure produced from a plurality of fibers that are combined in a manner that achieves a unified structure. A fabric may be a material that is formed by weaving or knitting a plurality of fibers or yarns that themselves are formed of a plurality of fibers. Such fabrics can be referenced as woven fabrics. A fabric may be a material that is formed by a plurality of fibers that are combined without weaving or knitting. Such fabrics can be referenced as non-woven fabrics.

As used herein, the term “film” refers to a thin layer of a polymer material. For the purposes of the present disclosure, a film is a substantially non-porous material, whereas a fabric is a porous material due to the presence of pores between the individual fibers.

As used herein, the term “fiber” is defined as a basic element of textiles. Fibers are often in the form of a rope- or string-like element. As used herein, the term “fiber” is intended to include fibers, filaments, continuous filaments, staple fibers, and the like. The term “multicomponent fibers” refers to fibers that comprise two or more components that are different by physical or chemical nature, including bicomponent fibers. Specifically, the term “multicomponent fibers” includes staple fibers and continuous filaments prepared from two or more polymers present in discrete structured domains in the fiber/filament, as opposed to blends where the domains tend to be dispersed, random or unstructured. The fibers may be selected from single-component (i.e., substantially uniform in composition throughout the fiber) or multicomponent fiber types including, but not limited to, fibers having a sheath/core structure and fibers having an islands-in-the-sea structure, as well as fibers having a side-by-side, segmented pie, segmented cross, segmented ribbon, or tipped multilobal cross-sections. Fibers can be hollow or non-hollow fibers, and further can have a substantially round or circular cross section or non-circular cross sections (for example, oval, rectangular, multi-lobed, and the like). It is noted that the fibers according to the present disclosure can vary, and include fibers having any type of cross-section, including, but not limited to, circular, rectangular, square, oval, triangular, and multilobal.

As used herein, the term “woven fabric” refers to any textile formed by weaving. Woven fabrics are often created on a loom, and made of many threads/fibers woven on a warp and a weft. Technically, a woven fabric is known in the art as any fabric made by interlacing two or more threads at right angles to one another. Woven fabrics can be prepared, if desired, from various types of yarns, such as, for example, various 2, 3, or 4 folded/ply yarns, core spun, or cable yarn. Yarns can be woven either in the warp or weft direction. The weave can be plain, twill, or satin, or any other conventional patterns to deliver a more aesthetic property to the pouch/pod. For knits, warp or weft knitting can be used along with variations in yarn count, weight, and the number of ribs and whales that can be used as long as the final pore structure is sufficient to hold the powder.

The term “nonwoven” is used herein in reference to fibrous materials, webs, mats, batts, or sheets in which fibers are aligned in an undefined or random orientation. The nonwoven fibers are initially presented as unbound fibers or filaments. An important step in the manufacturing of nonwovens involves binding the various fibers or filaments together. The manner in which the fibers or filaments are bound can vary, and include thermal, mechanical and chemical techniques that are selected in part based on the desired characteristics of the final product.

Nonwoven fabric forming methods for natural and synthetic fibers may include drylaid, airlaid and wetlaid methods. In some embodiments, the nonwoven fabric can be formed using a spunlaid or spunmelt process, which includes both spunbond and meltblown processes, wherein such processes are understood to typically entail melting, extruding, collecting and bonding thermoplastic polymer materials to form a fibrous nonwoven web. The technique of meltblowing is known in the art and is discussed in various patents, for example, U.S. Pat. No. 3,849,241 to Butin, U.S. Pat. No. 3,978,185 to Buntin et al., U.S. Pat. No. 3,972,759 to Buntin, and 4,622,259 to McAmish et al., each of which is herein incorporated by reference in its entirety. General spunbonding processes are described, for example, in U.S. Pat. No. 4,340,563 to Appel et al., U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartmann, and 30 3,542,615 to Dobo et al., which are all incorporated herein by reference.

The fabrics described herein can also be referred to as a fleece material. A “fleece material” as used herein may be formed from various types of water-soluble fibers. For example, fleece materials may be provided in the form of a woven or nonwoven fabric, and the presently disclosed fabric pouches may incorporate known methods and materials for forming thereof. For example, non-woven fabrics configured for retaining particulate matter therein (e.g., tea bags, etc.) are described in U.S. Pat. No. 7,498,281 to Iwasaki et al., the disclosure of which is incorporated herein by reference.

In some embodiments, the water-soluble fabric materials can have varying thicknesses, porosities and other parameters. For example, the water-soluble fabric material can be formed such that the fiber orientation and porosity of the material is altered to achieve the desired release characteristics of the releasable material contained therein.

The physical parameters of the fibers present in the water-soluble fabric material can vary. For example, the fibers used in the water-soluble fabric material can have varying size, such as length and dpf (denier per foot), and crimp characteristics. In some embodiments, fibers used in the water-soluble fabric material can be nano fibers, sub-micron fibers, and/or micron-sized fibers. In certain embodiments, fibers of the water-soluble fabric materials useful herein can measure about 1.0 dpf to about 3.0 dpf, or about 1.5 dpf to about 2.0 dpf. In various embodiments, the fibers of the water-soluble fabric materials can have a dpf of less than about 3.0 dpf, or less than about 2.5 dpf, or less than about 2.0 dpf. In some embodiments, each fiber can be a staple fiber. Each fiber length can measure about 35 mm to about 60 mm, or about 38 mm to about 55 mm, for example. In various embodiments, each fiber can measure about 4-10 crimps per cm, or about 5-8 crimps per cm. It can be advantageous for all fibers in the fleece material to have similar fiber size and crimp attributes to ensure favorable blending and orientation of the fibers in the fleece material. In some embodiments, fibers of various fiber deniers can be mixed or layered to form the fabric materials useful for the articles described herein in order to control powder/granule migration or dissolving rates of the water-soluble fabric material.

In various embodiments, the water-soluble fabric materials described herein have a permeability which ensures that liquid from the wash water permeates the water-soluble fabric material and provides a desirable rate of dissolution of the water-soluble fabric material, as well as the detergent formulation retained within the pouch formed of the water-soluble fabric material. It is noted that the permeability of the water-soluble fabric can vary dependent on how quickly the detergent is intended to be introduced into the laundry wash water. For example, high permeability will allow for faster dissolution of the fabric as well as faster infiltration of water to begin dissolution of the detergent formulation. In some embodiments, permeability can be defined relative to a pore size. Therefore, optimizing the permeability while maintaining good detergent retention prior to use of the unit-dose detergent article can be considered. In some embodiments, the water-soluble pouch material has an air permeability of at least about 10 ft³/ft²/min, at least about 20 ft³/ft²/min, at least about 25 ft³/ft²/min, at least about 30 ft³/ft²/min, at least about 40 ft³/ft²/min, or at least about 50 ft³/ft²/min, with a maximum of about 800 ft³/ft²/min, about 700 ft³/ft²/min, or about 600 ft³/ft²/min. In particular, air permeability can be in the range of about 20 ft³/ft²/min to about 600 ft³/ft²/min, about 25 ft³/ft²/min to about 550 ft³/ft²/min, or about 30 ft³/ft²/min to about 500 ft³/ft²/min. Air permeability can be measured using ASTM D737 using a pressure differential of 12.7 mm.

In various embodiments, the water-soluble fabric material can have pore sizes such that a significant portion of the laundry detergent formulation contained within the fabric material does not escape prior to use. Pore size can be calculated using formulas known in the art (e.g., the described in article by Cohen, ‘A Wet Pore-Size Model for Coverstock Fabrics’, Book of Papers: The International Nonwoven Fabrics Conference, INDATEC′90, Association of the Nonwoven Fabrics Industry, pp. 317-330 (1990)). Pore size thus can be calculated using Equation 1, provided below.

$$r = \frac{a ( \frac{{ρ}_{f}}{{ξρ}_{w}} - 1 )}{τ} \qquad [ Equation 1 ]$$

In Equation 1, a is the fiber radius, pf is the fiber density, p_{w} is the density of the fabric when dry, T is the tortuosity constant (e.g., 0.15 for woven/knits, and 1.44 for nonwovens), is a ratio of dry fabric density to wet fabric density, and r is the calculated pore radius. Note that two different tortuosity constants are used for woven/knits and for nonwovens due to the regularity of the structure of woven materials, which requires a lower tortuosity constant relative to nonwovens. Note also that fabric density as used in the equation arises from a caliper method where the fabric caliper is first recorded when dry, the fabric is saturated in the chosen liquid medium, and the fabric caliper is then recorded when wet. The value for is thus the ratio of the dry caliper to the wet caliper. For PVOH and similar, synthetic fibers, a ratio of 1 was used based on an assumption that swelling or collapsing would not have a significant occurrence because of the synthetic nature of the fibers and that the caliper reading for a wet sample would be substantially identical to that of the dry sample.

The pouch material can be configured to expressly have a pore size that prevents a significant content of the detergent formulation from escaping the water-soluble fabric material prior to use in a laundry machine. A “significant” content can be defined as 0.1% by weight, 0.2% by weight, 0.5% by weight, or 1% by weight based on the total starting weight of the pouched article including the initial dose of the laundry detergent formulation. In other words, the pouched article is configured so as to not lose more than the above-noted “significant” weight of the laundry detergent formulation from the time of forming the pouched article to the time of using the pouched article in a laundry machine, including during storage and transit of the pouched article. This feature can be achieved through proper combination of the pore size of the water-soluble pouch and the average particle size of the laundry detergent contained within the pouch. In various embodiments, the water-soluble fabric material or pouch has an average pore size of about 350 microns or less, about 300 microns or less, about 250 microns or less, about 200 microns or less, about 150 microns or less, or about 100 microns or less, with a minimum pore size of at least 5 microns, at least 10 microns, at least 20 microns, at least 30 microns, at least 40 microns, or at least 50 microns. In some embodiments, the water-soluble fabric material has an average pore size in the range of about 50 microns to about 350 microns, about 100 microns to about 300 microns, or about 150 microns to about 250 microns. Retention of the laundry detergent formulation within the pouch, and thus confirmation that the pouched article loses no more than the significant amount of the laundry detergent formulation prior to use in a laundry machine, can be tested by the Vartest/ICI tumbling method carried out by Vartest Laboratories 19 West 36th Street New York, N.Y. 10018 utilizing mass difference before and after tumbling. Testing methodology is described in the appended examples.

In some embodiments, the water-soluble fabric pouch can have a basis weight of about 5 gsm (grams per square meter) to about 150 gsm, about 10 gsm to about 130 gsm, about 20 gsm to about 120 gsm, or about 40 gsm to about 100 gsm. In certain embodiments, the fabric pouch can have a basis weight of less than about 150 gsm, less than about 140 gsm, less than about 120 gsm, less than about 110 gsm, or less than about 100 gsm, such as having a minimum of at least about 5 gsm, at least about 10 gsm, at least about 20 gsm, at least about 40 gsm, at least about 50 gsm, at least about 75 gsm, or at least about 100 gsm. Basis weight of a fabric can be measured using ASTM D3776/D3776M-09a (2013) (Standard Test Methods for Mass Per Unit Area (Weight) of Fabric), for example.

In various embodiments, the pouch material can have a layer thickness of less than about 0.5 mm, less than about 0.3 mm, less than about 0.2 mm, or less than about 0.15 mm (e.g., with a minimum of about 0.01 mm). In further embodiments, the pouch material can have a layer thickness of at least about 0.02 mm, at least about 0.05 mm, at least about 0.07 mm, or at least about 0.08 mm. In particular, the pouch material can have a layer thickness of about 0.05 mm to about 0.3 mm, about 0.08 mm to about 0.2 mm, or about 0.1 mm to about 0.15 mm (e.g., about 0.11 mm). The pouch material can have an elongation of about 10% to about 80%, or about 70% to about 80%, e.g., about 78%. In some embodiments, the pouch material can have a peak load of about 1 lb to about 8 lbs, or about 4 lbs. to about 8 lbs., e.g., about 5.5 lbs. In some embodiments, knit and woven water-soluble fabric materials can have tensile forces in the range of about 20 lbs to about 80 lbs. In various embodiments, knit and woven water-soluble fabric materials can have an elongation of about 50% to about 300%. Elongation and breaking strength of textile fabrics can be measured using ASTM D5034-09(2013) (Standard Test Method for Breaking Strength and Elongation of Textile Fabrics (Grab Test)), for example. In various embodiments, the fleece material can have a Tensile Energy Absorption (TEA) of about 35 to about 40, e.g., about 37. TEA can be measured, for example, as the work done to break the specimen under tensile loading per lateral area of the specimen. In certain embodiments, the fleece material can have a porosity of greater than about 10,000 ml/min/cm². Porosity, or air permeability of textile fabrics can be measured using ASTM D737-04(2012) (Standard Test method for Air Permeability of Textile Fabrics), for example.

The water-soluble fabric materials useful in the detergent pouches described herein can be formed from fibers comprising at least one polymer material, wherein the polymer material is at least partially water-soluble. In various embodiments, the water-soluble fabric materials described herein are formed from fibers comprising a polymer material that is substantially completely water-soluble or completely water-soluble. The polymer materials useful in the water-soluble fabric materials described herein can be partially, substantially completely, or completely water-soluble in cold water (e.g., water at a temperature of less than about 35° C.). Completely water-soluble is understood to mean at least 99.9% by weight of the polymer is solubilized in the water, and substantially completely water-soluble is understood to mean at least 98%, at least 98.5%, at least 99%, or at least 99.5% solubilized in the water.

The fibers used in the water-soluble fabric for forming the pouch can be formed of any polymer that is water-soluble and that is suitable for being formed into a fiber or filament as otherwise described herein. The polymer or polymers used in forming the fabric pouch can be selected as deemed useful to customize dissolution time, pouch strength, ability to seal the pouch, and overall pouch aesthetics (e.g., “look”, “feel”, and the like, as perceived by an average consumer). In some embodiments, the fibers forming the pouch material may include, but are not limited to, a polymer selected from the group consisting of polyvinyl alcohol (PVOH), polyethylene oxide, methyl cellulose, polyacrylates, and mixtures thereof. In various embodiments, the water-soluble fabric material comprises at least polyvinyl alcohol (PVOH). In addition, the pouch material can be formed such that it is configured for being heat sealed, for example, to seal the unit dose pouch once the detergent formulation is inserted therein.

In various embodiments of the present disclosure, a fiber is provided comprising a blend of water-soluble polymers. Preferably, such a fiber comprises a homogeneous blend of polymers. In various embodiments of the fibers described herein, polymer components of the homogeneous blend can be formed of the same or different polymers. As used herein, the “same” polymer refers to polymer components having an identical or similar chemical formula; however, each polymer component can differ with respect to their isomeric form, for example. In certain embodiments, different polymers having different temperatures at which the polymer dissolves can be utilized in different sections of the unit-dose laundry detergent article in order to control dissolution rates and/or powder/granule migration in the various sections of the article.

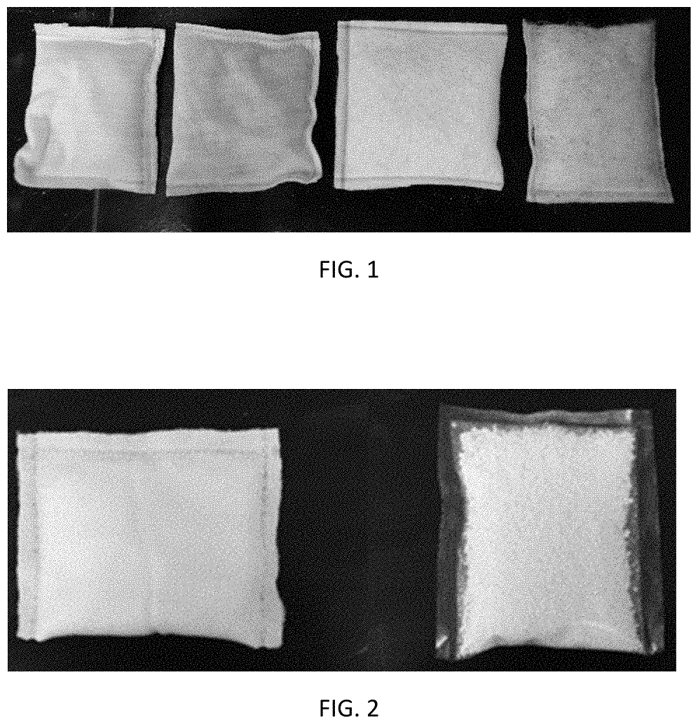

The laundry detergent package itself can be of any configuration, but conveniently may have a rectangular or square shape when viewed normally to the plane of its two longest dimensions. A rectangular or square packet is more easily manufactured and sealed than other configurations when using conventional packaging equipment. Example unit-dose laundry detergent articles are illustrated in FIG. 1. It is noted that the unit-dose laundry detergent articles can be provided in different sizes and weights (e.g., small, medium, large) to accommodate different consumer needs. The sizes can correspond to a recommended detergent dose for laundry fabric loads or levels of soil. The weight and dimensions of the unit-dose detergent articles are balanced to ensure quick and complete dissolution of the article in the wash water.

Detergent Formulation

The articles according to the present disclosure comprise a laundry detergent formulation that is provided within the pouch discussed above. Since the pouch is provided as a porous or non-film form, the detergent formulation, as provided within the pouch, is in a solid form rather than a liquid or gel form. The solid detergent formulation, as present within the pouch, can be provided in various different forms (e.g., particles, powders, tablets, granules, etc.). The detergent formulation is specifically configured for use in the porous pouch in that it is configured to begin dissolution almost immediately upon contact of the article with water due to the rapid infiltration of water through the pores of the fabric or other non-film pouch material. The detergent formulation is also configured to achieve rapid dissolution while also maintaining a sufficiently large particle size to be retained within the pouch according to the standards already described above. The detergent formulation beneficially can be provided in the necessary format for use in the porous pouch in light of the ability to modify a wide variety of detergent compositions, whether starting as a liquid or a solid. A detergent formulation is thus distinguishable from a detergent composition in relation to the presence or absence of a granulation aid, which is further discussed below. A detergent composition may be a typical detergent, whether solid, liquid, or otherwise, that is otherwise ready for use in washing processes. The detergent composition is blended with a granulation aid to form the detergent formulation that can be included in a pouch to form a detergent article according to the present disclosure. The materials likewise may be distinguished through use of the terms intermediate and final. An intermediate detergent is a detergent that has not been mixed with a granulation aid as described herein, and a final detergent is the detergent resulting from the blending of an intermediate detergent with a granulation aid.

A detergent formulation used in a pouched article according to the present disclosure can include any number of components that are typically useful in detergent compositions. Useful components in a laundry detergent composition, and thus in a laundry detergent formulation according to the present disclosure, can include any one or more of the following components (each of which may be present singly or as a plurality of different members of the noted group): surfactants, chelators, builders, alkalinizing agents, viscosifiers, bicarbonates, enzymes, enzyme stabilizers, dyes, optical brighteners, antiredeposition polymers, fluorescent whitening agents, fragrances, bittering agents, antifoaming agents, pH adjustors, bleaches, pearl luster agents, preservatives, and laundry boosters. Any of the above components, as well as other components typically found in such products, can be utilized in any composition or formulation as described, irrespective of form or intended use. Further, any other component described herein that is not otherwise defined as being required may be optionally, expressly excluded from embodiments of a laundry detergent composition or formulation. Any of the foregoing materials may be present in an intermediate detergent composition or a final detergent formulation in amount of 0% to about 20%, about 0.01% to about 15%, about 0.02% to about 10%, or about 0.05% to about 5.0% by weight based on the total weight of the intermediate detergent composition or the final detergent formulation. In other embodiments, any of the foregoing materials may be present in an intermediate detergent composition or a final detergent formulation in amount of 0% to about 4.0%, about 0.01% to about 3.0%, about 0.02% to about 2.0%, or about 0.05% to about 1.0% by weight based on the total weight of the intermediate detergent composition or the final detergent formulation.

Known solid detergent forms, such as powders, can have an average size that is unsuitably small for being retained in a porous pouch as presently described, and liquid forms likewise cannot be suitably retained in a porous pouch. Regardless of product form, however, the present disclosure can utilize a granulation aid that can be combined with an otherwise completed detergent composition and subjected to a granulation process that results in a particulate detergent formulation form that is suitably sized for use in the porous pouches of the present articles without significant loss of the detergent formulation prior to use in a laundry machine. The resulting particulate detergent formulation is also provided with desirable dissolution properties that are needed in an article where water can infiltrate the pouch for dissolution of the detergent formulation in the wash water almost immediately upon contact with the water.

A granulation aid for forming a detergent formulation useful in the pouched articles according to the present disclosure can be a polymer material. The polymer material used as the granulation aid can be expressly distinguished from any of the above-listed detergent components. This can be at least in part from the order of addition of the component (i.e., the polymer granulation aid is added after all other detergent components are combined to form the intermediate detergent composition that is then subjected to the granulation process). This can also be at least in part due to the relative content of the polymer granulation aid relative to other polymer components of known detergent compositions. This also can be at least in part due to the functionality of the polymer granulation aid in coagulation of smaller powders into larger particles or in entraining liquid detergent compositions so as to provide the liquid detergent formulation as a solid at room temperature and higher temperatures. Preferably, the polymer material is at least partially water soluble, is substantially completely water-soluble, or is completely water-soluble, such terms having the same meaning as already described herein. The polymer material used as the granulation aid for combination with the detergent compositions to from detergent formulations as described herein can be configured for binding the ingredients of the detergent composition into the desired particulate shape and size with the desired dissolution properties when retained within a porous pouch. The detergent particles resulting from the combination with the granulation aid thus can exhibit a form/size that meets the requirements otherwise described above for retaining the detergent formulation within the porous pouch.

In one or more embodiments, a polymer material useful as a granulation aid according to the present disclosure can be a polymer that is suitable for use in a wash water (i.e., acceptable for output to municipal water treatment plants or the environment, generally), that does not introduce undesired effects on the clothing or other fabric articles that are being laundered using the pouched article, that dissolves as discussed above in laundry washing conditions, and that has a suitably low melting point to provide for ease of combining with the solid or liquid intermediate detergent composition and a suitably high melting point so as to remain stable during shipping and storage conditions for the pouched articles after formation thereof. Suitable polymer materials may particularly be those that reversibly transition between solid and liquid states without significant gelation. Such melt-reversible polymer materials can be those that exhibit the properties already noted above along with the ability to provide a flowable composition above the melting temperature to allow for ease of mixing with the intermediate detergent composition and then easily transition back to solid form upon cooling below the melt temperature. Non-limiting examples of polymers meeting such characteristics include polyethylene glycol (PEG) polymers and ethylene oxide (EO) propylene oxide (PO) copolymers. Other polymer materials meeting such characteristics likewise can be used. On the other hand, it has been found according to the present disclosure that gelling polymers, such as gelatins and pectins, may incompatible for forming granules of detergents as described herein. Accordingly, in some embodiments, the present disclosure may expressly exclude the use of hydrocolloids or thickening/gelling polymers, such as agar, alginates, carageenan, cellulose derivatives (e.g., MCC, MHPC, HPC, CMC), exudate gums (e.g., gum arabic, gum tragacanth, gum karaya), gellan gum, konjac gum, modified starches, seed gums (e.g., locust bean gum, guar gum, and tara gum), and xanthan gum.

Suitable polymer materials may specifically be characterized in relation to melt temperature. In some embodiments, the polymer material used as the granulation aid preferably has a melt temperature of at least 40° C., at least 45° C., or at least 50° C., and that is no greater than 80° C., no greater than 75° C., or no greater than 70° C. In some embodiments, melt temperature can be about 40° C. to about 60° C.

In various embodiments, the polymer material can be a polyethylene glycol (PEG). PEG polymers can be defined in relation to the average molecular weight of the polymer material. PEG polymers useful according to the present disclosure can have an average molecular weight of at least about 1000 Da, at least about 2000 Da, at least about 3000 Da, at least about 4000 Da, at least about 5000 Da, or at least about 6000 Da. An upper end of a suitable molecular weight can be no more than about 25000 Da, no more than about 20000 Da, no more than about 15000 Da, or no more than about 10000 Da. The average molecular weight may be expressed as a “grade” of the polymer that is listed after the name (e.g., PEG 1000, PEG 8000, etc.) The PEG can be characterized as being a low molecular weight PEG since PEG can have a molecular weight exceeding several hundred thousand. A “low molecular weight PEG” thus can be a PEG having a molecular weight as described above or, more generally, as having a molecular weight of less than 25000 Da.

Molecular weight can be expressed as a weight average molecular weight (Mw) or a number average molecular weight (Mn). Both expressions are based upon the characterization of macromolecular solute containing solution as having an average number of molecules (ni) and a molar mass for each molecule (MO. Accordingly, number average molecular weight is defined by Equation 2 below.

$${M}_{n} = \frac{\sum {n}_{i} {M}_{i}}{\sum {n}_{i}} \qquad [ Equation 2 ]$$

Weight average molecular weight (also known as molecular weight average) is directly measurable using light scattering methods and is defined by Equation 3 below.

$${M}_{w} = \frac{\sum {n}_{i} {M}_{i}^{2}}{\sum {n}_{i} {M}_{i}} \qquad [ Equation 3 ]$$

Molecular weight can also be expressed as a Z-average molar weight (Mi), wherein the calculation places greater emphasis on molecules with large molar weights. Z-average molar weight is defined by Equation 4 below.

$${M}_{z} = \frac{\sum {n}_{i} {M}_{i}^{3}}{\sum {n}_{i} {M}_{i}^{2}} \qquad [ Equation 4 ]$$

Unless otherwise noted, molecular weight (MW) is expressed herein as weight average molecular weight.

Without intending to be limited by theory, it was surprisingly discovered according to the present disclosure that use of a low molecular weight polymer granulation aid (e.g., PEG 8000) can allow for both of the binding capability (i.e., for granulation to form appropriately sized particles) and the water solubility required for preparation of laundry detergent articles as described herein. Low molecular weight PEG polymers also can provide additive laundry cleaning benefits. Laundry Wash Performance Testing was performed following ASTM D4265 Standard Guide for Evaluating Stain Removal Performance in Home Laundering. Results shown in the appended examples indicated that a laundry detergent formulation prepared using PEG 8000 as a granulation aid provided higher removal of several stains/soils from cotton and polycotton as compared to the laundry detergent without the PEG 8000 granulation aid. The additive effect can be an improvement of at least 5%, at least 8%, at least 10%, or at least 12%.

As noted above, suitable polymers for use as the granulation aid can include ethylene oxide (EO) propylene oxide (PO) copolymers, specifically those of the EO-PO-EO type. These polymers can be particularly useful since they display surface active behavior in addition to polymeric properties. These EO-PO-EO block copolymers are commercially available from BASF under the trade name Pluronic® and are also referred to generically as poloxamer surfactants. Especially preferred in this invention are those poloxamer materials having a melting point in the ranges discussed above. A single poloxamer or a plurality of poloxamers can be used, and combinations can be used to customize melting temperature.

A granulation aid as described herein likewise can comprise one or more polymers that are similar in structure to poloxamers. For example, Pluronic® R surfactants, which are polymers composed of a PO-EO-PO block structure, may be used. Pluronic® R surfactants exhibit similar physical properties to those of Pluronic® surfactants, and can therefore be used as a granulation aid meeting the parameters discussed above.

Additional polymeric surfactants which may be employed as a polymer granulation aid can include ethylene diamine that is tetrafunctionally modified with PO-EO block groups. These polymers are commercially available under the trade name Tetronic®. As with the other polymers mentioned, any Tetronic® R or mixtures thereof may be employed as long as the material meets the discussed requirements.

In various embodiments, the at least one polymer material utilized as a granulation aid can be present in the final detergent formulation included in the pouched article an amount of at least about 10% by weight, at least about 15% by weight, at least about 20% by weight, at least about 25% by weight, at least about 35% by weight, at least about 40% by weight, or at least about 45% by weight based on the total weight of the detergent formulation. The polymer material can be present at a maximum amount of about 95% by weight or less, about 80% by weight or less, about 70% by weight or less, or about 60% by weight or less. In various embodiments, the at least one polymer material is present in an amount of about 10% to about 60% by weight, about 15% to about 50% by weight, about 20% to about 45% by weight, or about 25% to about 35% by weight, based on the total weight of the detergent formulation.

In one or more embodiments, the present disclosure also encompasses methods of making a detergent formulation with improved properties for use particularly in a porous pouch material. The method can comprise providing a detergent composition (powdered or liquid) in a form that is otherwise configured as a complete detergent. This can be characterized as an “intermediate” detergent composition as the composition is subject to further processing to achieve the formulation of the present disclosure. The intermediate detergent composition can be blended with a suitable amount of the polymer material used as the granulation agent, the polymer material being in a melted and flowable condition. The polymer material can be melted, for example, using a ToAuto Wax Melter. The melted polymer material can be added to a suitable unit configured for maintaining the polymer in the melted form during addition of the intermediate detergent composition. Once blended for a time suitable to achieve a substantially uniform mixture, the combined formulation can be allowed to solidify. This can be carried out, for example, using a plurality of molds. The molds can be sized to provide the solid formulation substantially in the form of tablets or other shapes sufficiently sized for processing in a granulator.

The solidified tablets or units of the detergent/polymer combination can then be processed in a granulator at the required combination of throughput speed and screen size to achieve a desired average particle size provided as the finished detergent formulation. The finished formulation can be screened to achieve a particle size distribution as desired. In various embodiments, the finished detergent formulation for inclusion within the porous pouches can have an average particle size that is greater than 0.08 mm (80 microns), greater than 0.1 mm (100 microns), greater than 0.2 mm (200 microns), greater than 0.4 mm (400 microns), greater than 0.6 mm (600 microns), greater than 0.8 mm (800 microns), or greater than 0.9 mm (900 microns). The particles can have a maximum average particle size that varies based on the desired dissolution properties and/or aesthetic properties desired. For example, it may be desirable to maintain a substantially powder-like appearance, and a maximum size may be less than 1.5 mm, less than 1.2 mm, or less than 1 mm. If a larger particle is desired, average size may be up to 2 mm, up to 2.5 mm, up to 3 mm, up to 4 mm, or up to 5 mm. Even larger sizes are not necessarily excluded with the understanding that increasing particle size can be used to provide extended dissolution time for the detergent formulation in the wash water. In certain embodiments, particle size can be about 0.08 mm to about 2 mm, about 0.1 mm to about 1.5 mm, about 0.2 mm to about 1.2 mm, or about 0.4 mm to about 1 mm.

As noted, the detergent formulation includes any combination of components that are typically used in detergent compositions. For example, a typical solid detergent composition can comprise about 10% to about 15% by weight of water, about 2% to about 15% by weight of surfactants, about 75% to about 86% by weight of builders, and about 0.01% to about 13% by weight of other components chosen from the list of components already provided above. A typical liquid detergent composition can comprise about 65% to about 80% by weight of water, about 2% to about 15% by weigh of surfactants, about 0.1% to about 3% by weight of builders, and about 2% to about 20% by weight of other components chosen from the list of components already provided above.

A detergent formulation according to the present disclosure that is a combination of a detergent composition and a granulation aid can include at least certain components of typical detergent compositions. For example, an intermediate detergent composition or a completed detergent formulation according to the present disclosure can include at least a surfactant and/or at least a builder.

A wide variety of anionic surfactants and/or nonionic may be used according to the present disclosure. In various embodiments, a suitable anionic surfactant may include one or more salts (e.g., sodium, potassium, ammonium, and substituted ammonium salts such as mono-, di- and triethanolamine salts) of anionic sulfates, sulfonates, carboxylates, and sarcosinates. Exemplary anionic sulfates can include linear and/or branched primary and secondary alkyl sulfates, alkyl ethoxysulfates, fatty oleoyl glycerol sulfates, alkyl phenol ethylene oxide ether sulfates, C₅-C₁₇ acyl-N—(C₁-C₄ alkyl) and —N—(C₁-C₂ hydroxyalkyl) glucamine sulfates, and sulfates of alkylpolysaccharides, such as alkylpolyglucoside sulfates. Exemplary alkyl sulfates can include linear and branched primary C₁₀-C₁₈ alkyl sulfates. Exemplary alkyl ethoxysulfate surfactants can include C₁₀-C₁₈ alkyl sulfates that have been ethoxylated with from 0.5 to 20 moles of ethylene oxide per molecule. Exemplary anionic sulfonate surfactants can include salts of C₅-C₂₀ linear alkylbenzene sulfonates, alkyl ester sulfonates, C₆-C₂₂ primary or secondary alkane sulfonates, C₆-C₂₄ olefin sulfonates, sulfonated polycarboxylic acids, alkyl glycerol sulfonates, fatty acyl glycerol sulfonates, fatty oleyl glycerol sulfonates, and any mixtures thereof. Exemplary anionic carboxylates can include alkyl ethoxy carboxylates, and alkyl polyethoxy polycarboxylates. In some embodiments, preferred anionic surfactants can include various sulfates (e.g., alkyl ether sulfates, such as laureth sulfate salts), alkyl ester sulfonates, and alkylbenzene sulfonate (e.g., C₅ to C₂₀ or C₁₀ to C₁₆). Non-limiting examples of anionic surfactants that may be used herein include sodium laureth sulfate (SLES), sodium lauryl sulfate (SLS), methyl ester sulfonate (MES), and sodium C₁₀-16 alkylbenzene sulfonate (LAS). In certain embodiments, ethoxylated anionic surfactants may be utilized and may comprise a limited number of moles of ethylene oxide groups. For example, an alkyl ether sulfate anionic surfactant may comprise less than 5 moles, or less than 4 moles of ethylene oxide groups, such as 1 to 4 or 2 to 3 ethylene oxide groups.

In various embodiments, a suitable nonionic surfactant may include alkyl ethoxylate condensation products of aliphatic alcohols with from 1 to 25 moles of ethylene oxide wherein the alkyl chain of the aliphatic alcohol can either be straight or branched, primary or secondary, and generally contains from 6 to 22 carbon atoms. Further suitable nonionic surfactants can include water soluble ethoxylated C₆-C₁₈ fatty alcohols and C₆-C₁₈ mixed ethoxylated/propoxylated fatty alcohols. For example, the ethoxylated fatty alcohols can be C₁₀-Cis ethoxylated fatty alcohols with a degree of ethoxylation of from 3 to 20. In some embodiments, mixed ethoxylated/propoxylated fatty alcohols can have an alkyl chain length of from 10 to 18 carbon atoms, a degree of ethoxylation of from 3 to 30, and a degree of propoxylation of from 1 to 10. In further embodiments, suitable nonionic surfactants can include those formed from the condensation of ethylene oxide with a hydrophobic base formed by the condensation of propylene oxide with propylene glycol. Examples of compounds of this type include certain of the commercially-available Pluronic™ surfactants, marketed by BASF. Further, suitable nonionic surfactants can include those formed from the condensation of ethylene oxide with the product resulting from the reaction of propylene oxide and ethylenediamine. Examples of this type of nonionic surfactant include certain of the commercially available Tetronic™ compounds, marketed by BASF. In certain embodiments, suitable nonionic surfactants can be selected, for example, from various alcohol ethoxylates. In some embodiments, the nonionic surfactant can be defined in relation to the alcohol chain length and/or the number of ethoxylate groups present in the molecule. For example, the nonionic surfactant can comprise an alcohol ethoxylate formed from an alcohol with a carbon chain length of 3 to 20 carbon atoms, 5 to 20 carbon atoms, 7 to 19 carbon atoms, 9 to 18 carbon atoms, 10 to 17 carbon atoms, or 12 to 15 carbon atoms. As a further example, the nonionic surfactant can comprise an alcohol ethoxylate having 2 to 10, 4 to 9, or 6 to 8 moles of ethylene oxide per mole of alcohol. Non-limiting examples of nonionic surfactants that may be used herein include ethoxylated alcohols (AE) (C₁₂-15 alcohols, in particular), such as those available under the tradename NEODOL®, lauryl or myristyl glucosides (APG), and polyoxyethylene alkylethers (2° AE).

Suitable builders can include materials that are effective as alkalinizing agents. For example, various alkali carbonates and/or other inorganic alkalinizing agents may be utilized to increase the pH of the laundry detergent composition while simultaneously increasing the viscosity to a desired level. Preferably, sodium and/or potassium salts (e.g., K₂CO₃ and/or Na₂CO₃) may be used. For example, soda ash can be used. In some embodiments, one or more components may be utilized for formation of a carbonate in situ. For example, bicarbonates and hydroxides in combination can be effective for in situ formation of a carbonate. In an example embodiment, sodium bicarbonate and sodium hydroxide may be utilized for this purpose, and other forms of bicarbonates and hydroxides may likewise be utilized.

In various embodiments, about 5 g to about 20 g, or about 8 g to about 15 g (e.g., about 10 g) of the finished detergent formulation in the form of a plurality of particles can be included in the pouch. As noted above, the dimensions of the pouch and the weight of the detergent enclosed therein can be balanced to ensure fast and complete dissolution of the pouch and the included detergent formulation in the wash water.

Detergent particle size can be chosen to be matched with average pore size in the fabric pouch in which it is to be retained in order to achieve the desired particle retention or loss of product from the pouch. The discloses articles thus can be prepared to have a ratio of detergent particle size to fabric average pore size so that the ratio is about 1.6 or greater, about 2 or greater, about 4 or greater, about 6 or greater, about 8 or greater, about 10 or greater, about 12 or greater, about 14 or greater, or about 16 or greater. A maximum ratio may be no more than 50, no more than 40, no more than 30, or no more than 25. In certain embodiments, the ratio can be about 1.6 to about 50, about 2 to about 40, about 6 to about 35, about 8 to about 30, or about 10 to about 25.

The above ratios do not rely only on matching average particle size to average fabric pore size due to the unpredictable effect of fabric tortuosity. Although smaller average pore size may generally lead to lower loss of particles through the pores, product permeability and product porosity do not have a direct correlation at least because of the impact of fabric structure tortuosity. Specifically, nonwoven fabrics provide a significantly greater tortuosity for passage of a particle through the fabric relative to a woven fabric with regular pore spacing. This phenomenon increases with fabric weight and thickness. As such, it is possible to prepare fabrics with suitable basis weights and fabric densities that exhibit high permeability for air and liquid but very low permeability for particles due to the highly tortuous path formed in the nonwoven fabric. The above ratios take into account the effect of fabric tortuosity in order to obtain articles where the fabric pouches provide the necessary particle retention in consideration of at least fabric basis weight, fabric density, and fabric thickness in addition to average pore size. The ratios likewise enable selection of desirably small particle sizes to facilitate rapid dissolution in wash water without choosing an unnecessarily small fabric average pore size.

### EXPERIMENTAL

### Example 1—Formation of Laundry Detergent Formulation

A conventional, powdered detergent composition was provided and comprised about 10-15% by weight water, about 2-15% by weight surfactants, about 75-86% by weight builders, and about 0.01-13% by weight of other, typical laundry detergent components (e.g., enzymes, enzyme stabilizer, antiredeposition polymer, fragrance, dye, preservative, defoamer, optical whitening agent, or other materials described herein).

Polyethylene glycol having an average molecular weight of about 8000 (i.e., PEG 8000) was melted and was mixed with the powder detergent composition at the following ratios: 50% PEG 8000/50% detergent; 40% PEG 8000/60% detergent; 25% PEG 8000/75% detergent; and 35% PEG 8000/65% detergent.

Pluriol™ E 8000 Pastille PEG was used as the PEG material. The PEG was melted using a Fisher Scientific Isotemp Digital Magnetic Stirrer/Hotplate. The PEG and detergent in the noted amounts were mixed using an IKA Werke EUROSTAR Power-B Overhead Stirrer Mixer with a propeller at 700 rpm. These mixtures were then placed in molds and set at room temperature until solid.

For the samples with higher concentrations of detergent, the mixtures started to crystallize while being poured into the mold, so the samples were placed in the microwave for 15 seconds to re-melt such that they went into the molds easier. Once the PEG-detergent mixtures in the molds were cooled, they were then ground using a KitchenAid stand mixer Grain Mill attachment. The granule products post-grind were passed through a sieve of size 20 US Mesh, or 841 μm.

Solubility testing was then performed on the granules. Ten (10) grams of sample was dissolved in 1600 mL of room temperature water and the time in which all granules dissolved was recorded as the solubility time. A 2000 mL glass beaker was used for this test as well as an IKA Werke EUROSTAR Power-B Overhead Stirrer Mixer with a propeller, mixing at 700 rpm. A stopwatch was used to measure time.

The percent yield of the material retained on the 20 US Mesh sieve for the PEG/CPD mixtures was calculated and reported in Table 1 below. The following equation was used to calculate the percent yield of each sample:

$$Percent yield = ( \frac{Mass of + 20 US Mesh}{Post Grind Total Weight} ) * 100$$

TABLE 1

| | PEG | Pre-Grind | | | Post-Grind | | Solubility |
|---|---|---|---|---|---|---|---|
| Detergent | 8000 | Bar Weight | +20 US | | Total | Percent | Time |
| (%) | (%) | (g) | Mesh (g) | Pan (g) | Weight (g) | Yield (%) | (min:sec) |
| 50 | 50 | * | 38.50 | 105.91 | 144.41 | 26.66 | 4:30 |
| 60 | 40 | 180.75 | 49.84 | 121.57 | 171.41 | 29.08 | 4:22 |
| 75 | 25 | 132.44 | 33.80 | 97.07 | 130.87 | 25.83 | 3:20 |
| 65 | 35 | 178.92 | 47.23 | 126.66 | 173.89 | 27.16 | 3:45 |

The different percentages of detergent mixed with PEG 8000 did not result in different percent yields for any of the mixtures. The solubility times, however, were affected by the amount of detergent present. Results showed that higher concentrations of detergent in the mixture led to better solubility of the granules. The mixture with 75% detergent solubilized in water in the shortest amount of time and the mixture with 50% detergent solubilized in the longest amount of time. Without being limited by theory, these results make sense in that the detergent ingredients possibly have higher water solubility or faster dissolution compared to the PEG 8000 polymer.

After preparing the granulated laundry detergent comprising the PEG 8000, 10 grams of the laundry detergent granules was sealed inside a water-soluble fabric sheet using a tabletop impulse heat sealer to form a pouch. The fabric materials used were 100 gsm PVOH filament knit fabric available from Gepco Inc., Kennesaw, Ga. Photographs of the successfully formed pouches are seen in FIG. 1.

### Example 2—Effect of Polymer on Solubility of Detergent Granules

Another two samples of PEG-detergent molds were made according to Example 1 above. One sample containing 40% PEG 8000 and 60% detergent was made and ground in the same manner as described above for further testing. The other sample comprised 40% Brijs100 (Polyoxyethylene (100) stearyl ether) and 60% detergent. Brijs100 is a different water-soluble polymer and was chosen to compare against PEG 8000. The granules from each sample were then enclosed into fabric pouches. Ten (10) grams of each sample granules were heat-sealed into fabric pouches using a tabletop impulse heat sealer, creating rectangular pouches, the fabric being 100 gsm PVOH filament knit fabric available from Gepco Inc., Kennesaw, Ga.

Solubility data of the fabric pouches containing the 40% PEG 8000/60% detergent samples and the fabric pouches containing the 40% BRIJ S100/60% detergent samples can be found below in Table 2. The fabric pouches containing the PEG granules dissolved significantly faster than those containing the BRIJ granules.

TABLE 2

| | | Total Pouch | Solubility Time |
|---|---|---|---|
| Material | Replicates | Weight (g) | (min:sec) |
| 40% PEG 8000 + | Replicate 1 | 10.58 | 8:45 |
| 60% detergent | Replicate 2 | 10.66 | 8:27 |
| | Replicate 3 | 10.73 | 8:28 |
| 40% BRU S100 + | Replicate 1 | 10.67 | 17:02 |
| 60% detergent | Replicate 2 | 10.73 | 25+ |
| | Replicate 3 | 10.66 | 20:00 |

### Example 3—Effect of Pouch Material on Dissolution Rate

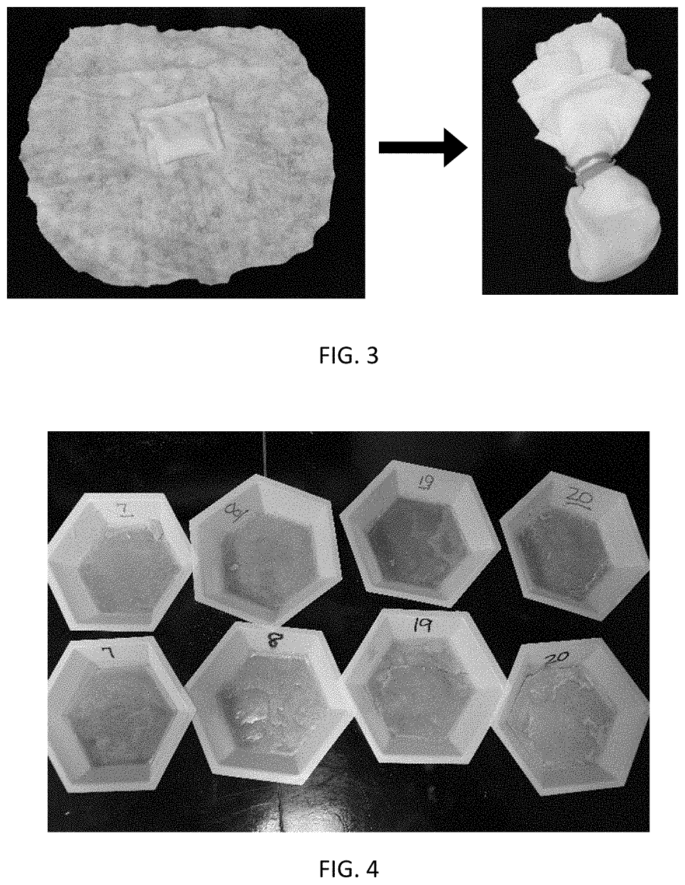

The granules made according to Examples 1 and 2 above were enclosed in two different encapsulating materials: a water-soluble fabric comprising 100 gsm PVOH filament knit fabric available from Gepco Inc., Kennesaw, Ga.; and a water-soluble film PVOH film (i.e., non-porous and thus similar to commercially available unit dose laundry pods). Ten (10) grams of the granules were enclosed inside water-soluble fabric by heat sealing, using a tabletop impulse heat sealer and creating a rectangular pouch. Another 10 grams of the granules were heat-sealed inside a water-soluble PVOH film, creating another rectangular pouch. Examples of the two different pouches containing the same granules can be seen in FIG. 2 (water-soluble PVOH fabric pouch (left) and water-soluble PVOH film pouch (right)) containing the same granules. Each granule-filled pouch was covered with water-insoluble fabric and tied with a rubber band, creating larger pouches which can be seen in FIG. 3. These larger pouches were immersed in 10° C. water in a beaker and stirred in the cold water using a Fisher Scientific Isotemp Digital Magnetic Stirrer/Hotplate and large magnetic stir bar. After 5 minutes, the pouches were removed from the beaker. The pouches were left at room temperature in a drying cabinet for two days and then weighed when dry. Percent residues were calculated from the amount remaining undissolved material from the water-soluble fabric pouch with granules.

Results from the residue testing of the water-soluble pouches tied inside water-insoluble fabric was shown in Table 3 below. When placed inside the water-insoluble fabric, the pouch of granules enclosed with water-soluble PVOH fabric dissolved better than the pouch with water-soluble PVOH film. The presence of the water-insoluble fabric caused retardation of water reaching the pouches. This result showed that there is an advantage to using fabric PVOH as encapsulating material if less water is available to completely dissolve the unit dose pouch, such as in a laundry washer with a very high fabric load. Without intending to be limited by theory, it is possible that the high porosity of the fabric PVOH allowed better diffusion/dissolution of the cold water compared to the film PVOH, resulting in lower percent of remaining residues.

TABLE 3

| Test | Product Inside | Product Weight | Percent residue |
|---|---|---|---|
| Sample | Fabric | (g) | (%) |
| A | Fabric Pouch | 10.85 | 0.7613 |
| B | Film Pouch | 10.79 | 3.0074 |

### Example 4—Preparation of Laundry Detergent Formulations

Test formulations were prepared using: a typical liquid laundry detergent having a composition as already described above; PEG 8000 polymer (Pluriol E 8000 Prills); and one additional material chosen from the following list: diethylenetriaaminepentaacetic acid DTPA chelating agent (4% aqueous solution, 2% actives DTPA), dipropylene glycol—solvent, cocamidopropylbetaine surfactant (10% aqueous solution), extended chain surfactant (10% aqueous solution), and amphoteric surfactant (10% aqueous solution). Fabric pouches were used and comprised 100 gsm PVOH filament knit fabric available from Gepco Inc., Kennesaw, Ga.

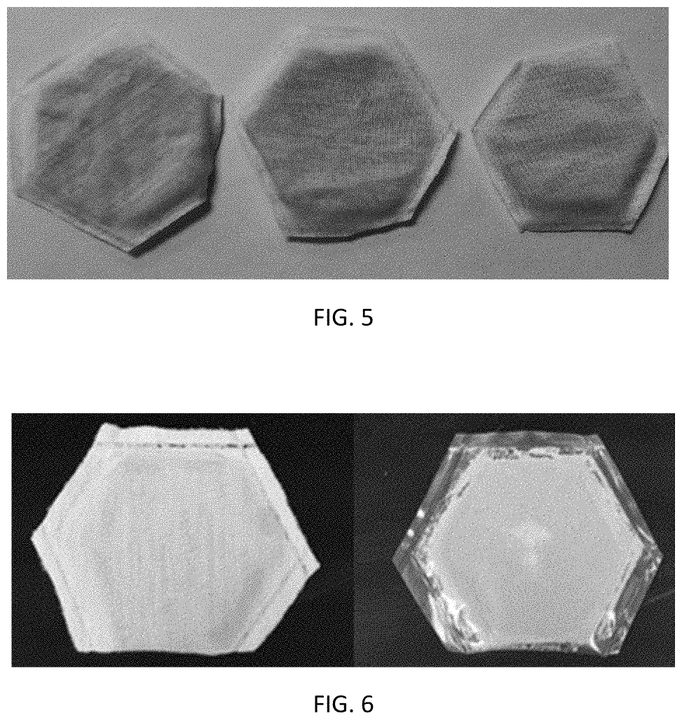

A phase composition study was performed with the combination of liquid laundry detergent, binding polymer granulation aid, and an additional ingredient that was either a chelating agent, a solvent, or a surfactant. These additional ingredients were evaluated either as additional cleaning ingredients (chelating agent or surfactant), or as solvent to help solubilize the ingredients of the mixture. Combinations of detergent, polymer, and additive were added in beakers in various different ratios. The mixtures that did not immediately separate were remade in 15-g batches, poured into small weigh boats and dried overnight in a 50° C. laboratory oven to form laundry detergent tablets with 1-cm thickness (FIG. 4). The resulting laundry tablets were then enclosed in fabric polyvinyl alcohol using a tabletop impulse heat-sealer. (FIG. 5).

Not all combinations of liquid laundry detergent, polymer and additional ingredient showed stable mixtures. Combinations added with chelating agent or solvent showed phase separation. Combinations including cocamidopropylbetaine (extended chain surfactant) showed homogeneous mixtures that upon drying resulted in tablets that are uniform in appearance, have smoothest texture and without being soft or brittle. The best results were seen using the following ratios of detergent/polymer/cocamidopropylbetaine: 70%/20%/10%; 50%/40%/10%; 50%/20%/30%; and 35%/35%/30%.

The moisture percentage in the detergent tablets was measured, as indicated in Table 4 below.

TABLE 4

| Weight (g) | Moisture % | Drying Time (° C.) | Average Moisture % |
|---|---|---|---|
| 1.073 | 16.59 | 105 | 16.09 |
| 1.039 | 17.04 | 105 | |
| 1.04 | 17.79 | 105 | |
| 0.929 | 14.64 | 105 | |
| 1.015 | 14.29 | 105 | |
| 1.013 | 16.19 | 105 | |

In a cold water-dissolution testing, the laundry detergent tablet enclosed within the fabric PVOH started to dissolve in 1 L of 9.8° C. water within 1 minute 15 seconds, and 75% dissolved within 10 minutes with mixing.

### Example 5—Preparation of Laundry Detergent Formulation

A liquid laundry detergent, PEG 8000 (Pluriol™ E 8000 Prill), and Surfonic X-AES were heated and mixed together in the following percentages: 70% detergent, 20% PEG 8000, and 10% Surfonic X-AES. The liquid laundry detergent had the general composition as otherwise described herein. This mixture was based on the Phase Composition Study (described in Example 4 above) as a combination showing formula stability (no phase separation). The extended chain surfactant Surfonic X-AES was chosen to improve cleaning efficacy of the final detergent formulation, such as for greasy or oily soiling material. All components were put into a 50 mL glass beaker and set on a Fisher Scientific Isotemp Digital Magnetic Stirrer/Hotplate set to 150° C. The mixture was stirred with a small magnetic stir bar at about 300 rpm until the PEG melted and the mixture was homogeneous. The resultant sample was poured into a small plastic weigh boat to set at room temperature overnight. The resulting tablets were then used in further testing.

One tablet was heat-sealed in a water-soluble PVOH fabric according to the present disclosure (100 gsm PVOH filament knit fabric available from Gepco Inc., Kennesaw, Ga.) and another tablet was heat-sealed in a water-soluble PVOH film using a tabletop impulse heat sealer. Examples of the two tablets can be seen in FIG. 6 (Water-Soluble PVOH Fabric Tablet (left) and Water-Soluble PVOH Film Tablet (right)).

Residue testing was performed on the water-soluble PVOH fabric tablet and on the water-soluble PVOH film tablet after tying each inside water-insoluble fabric with a rubber band. Percent residues were calculated from the amount remaining undissolved from the water-soluble PVOH enclosed tablet.

When placed inside the water-insoluble fabric, the tablet enclosed with water-soluble PVOH fabric dissolved better than the tablet enclosed with water-soluble PVOH film. The presence of the water-insoluble fabric caused retardation of water reaching the tablets. These findings showed that there is an advantage to using fabric PVOH as encapsulating material if less water is available to completely dissolve the laundry detergent tablet, such as in a laundry washer with very high fabric load. It is believed that the high porosity of the fabric PVOH allowed better diffusion of water and dissolution of the tablet in cold water, compared to the film PVOH, resulting in lower % residues (Table 5).

TABLE S

| Product Inside Fabric | Product Weight (g) | Percent residue (%) |
|---|---|---|
| Fabric PVOH-Enclosed | 13.66 | 90.1918 |
| Tablet | | |
| Film PVOH-Enclosed | 13.74 | 96.8399 |
| Tablet | | |

### Example 6—Porosity Evaluation

The porosity of different water-soluble fabric material types was calculated using Equation 1 of the disclosure to confirm the ability to provide woven and nonwoven fabrics formed of water-soluble fibers with sufficiently small pore sizes to hold a detergent formulation with average particle sizes within the ranges otherwise described herein. Six pouch material samples were evaluated: 1) PVOH fibers warp knitted with spun yarn with a NE 50/1 count to provide a 100 gsm woven fabric, PVOH grade AA (dissolving temperature of 15-25° C., laboratory measured average pore size of 0.28 mm (0.011 inches, or 11 mils) in the machine direction and 0.16 mm (0.006 inches or 6.2 mils) in the cross direction; 2) PVOH fabric as in sample 1 but with PVOH filaments of lower denier; 3) nonwoven PVOH, 1.7 denier per foot (dpf), spunbonded; 4) nonwoven PVOH, 3.0 dpf, calendar bonded; 5) nonwoven PVOH, 3.0 dpf, needle punched; and 6) nonwoven PVOH, 2.2 dpf, through air bonded.

While various water-soluble fiber materials can be used to prepare woven, knitted, or nonwoven materials for use as a pouch for the presently disclosed articles, selection of size, dpf, basis weight, and fabric density can be critical to ensure capture of detergent particles in a desired size range, such as particles with an average size of within the ranges otherwise described herein. The fabric porosity can be determined by using the Cohen equation (Equation 1 provided above), as illustrated in Table 6 below.

TABLE 6

| | | | | Calendar | Needle | Through |
|---|---|---|---|---|---|---|
| Property | Knit 1 | Knit 2 | Spunbond | Bond | Punch | Air Bond |
| Fiber density (g/cc) | 1.23 | 1.23 | 1.23 | 1.23 | 1.23 | 1.23 |
| Fiber density (g/cc) | 1.23 | 1.23 | 1.23 | 1.23 | 1.23 | 1.23 |
| Denier | 3 | 2 | 1.7 | 3 | 3 | 2.2 |
| Fabric area | 2.71 × E⁻¹⁰ | 1.81 × E⁻¹⁰ | 1.54 × E⁻¹⁰ | 2.71 × E⁻¹⁰ | 2.71 × E⁻¹⁰ | 1.99 × E⁻¹⁰ |
| Radius (microns) | 9.29 | 7.59 | 6.99 | 9.29 | 9.29 | 7.96 |
| Basis weight (gsm) | 100 | 100 | 30 | 30 | 80 | 27 |
| Thickness (mm) | 0.34 | 0.34 | 0.34 | 0.5 | 0.95 | 0.95 |
| fabric density (g/cc) | 0.29 | 0.29 | 0.09 | 0.06 | 0.08 | 0.03 |
| Pore Size (microns) | 230.86 | 188.50 | 51.56 | 103.76 | 72.075 | 193.72 |

The Cohen model was accurate when compared to actual measurements of the knit material used in the prototype samples and has shown excellent powder retention. The theoretical pore size was estimated at 231 microns where the pore size measurement in the laboratory was between 160 and 280 microns.

To confirm the calculated values, various nonwoven fabrics and knit fabrics were produced using water-soluble fibers. Density, permeability, strength, and pore size were measured for each fabric sample produced. The fabrics were formed into pouches and filled with detergent particles having an average particle size of about 800 microns. Particle release from the pouch was measured using the CI Tumbling Test. The tumbling apparatus for carrying out the test is described in ISO 12945-3:2014, “Textiles—Determination of the fabric propensity to surface pilling, fuzzing or matting—Part 3: Random tumble pilling method.” The test samples were conditioned according to ASTM D1776. The detergent pouches were placed in a one plastic bag with zip closure and then tumbled in the apparatus at 40 RPM for 100 cycles, and the mass loss of the pouch was measured using a Mettler 5 place balance. The following test samples for fabrics according to the present disclosure were prepared.

Test Sample 1—Calendar point bonded nonwoven fabric from Southeast Nonwovens Inc, Clover, N.C. made with Kurrary 100% PVOH Kuralon K-II WN2 1.7 T fibers.

Test Sample 2—Needle punched nonwoven fabric from Southeast Nonwovens Inc, Clover, N.C. made with Kurrary 100% PVOH Kuralon K-II WN2 1.7 T fibers.

Test Sample 3—Calendar point bonded nonwoven fabric from Southeast Nonwovens Inc, Clover, N.C. made with 50% Kurrary PVOH Kuralon K-II WN2 1.7 T fibers and 50% soluble acrylate (Code 100/52/7) from Technical Absorbents Grimsby, North East Lincolnshire, UK.

Test Sample 4—Needle punched nonwoven fabric from Southeast Nonwovens Inc, Clover, N.C. made with 50% Kurrary PVOH Kuralon K-II WN2 1.7 T fibers and 50% soluble acrylate (Code 100/52/7) from Technical Absorbents Grimsby, North East Lincolnshire, UK.

Test Sample 5—Spunbond 100% PVOH made by Aquapak Polymers Birmingham, UK.

Test Sample 6—100% PVOH (100 gsm) warp knitted, yarn dimension spunyarn count NE 50/1 sourced from Gepco Inc. Kennesaw, Ga. USA.

Tested values for each of the test samples is provided in Table 7. Although smaller average pore size may generally lead to lower loss of particles through the pores, product permeability and product porosity do not have a direct correlation at least because of the impact of fabric structure tortuosity. Specifically, nonwoven fabrics provide a significantly greater tortuosity for passage of a particle through the fabric relative to a woven fabric with regular pore spacing. This phenomenon increases with fabric weight and thickness. As such, it is possible to prepare fabrics with suitable basis weights and fabric densities that exhibit high permeability for air and liquid but very low permeability for particles due to the highly tortuous path formed in the nonwoven fabric.

The test fabrics according to the present disclosure targeted pore size and fabric structure to contain particles having an average size of no less than 800 microns. Testing identified a preferred ratio of detergent particle size to fabric average pore size to achieve the desired resistance to particle loss. The preferred ratio was found to be in the range of about 1.6 or greater, and particular about 8 or greater or about 16 or greater. Such ratio would likewise apply to any of the particle size ranges and pouch fabric pore sizes described herein.

Particle release on tumbling was measured using the CI Tumbling Test described above. Average pore size of the fabrics was evaluated by Vartest Laboratories, New York, N.Y. using the SOP 926-11 Pore Size Method. Pore sizes were measured using an Askania Stereo Microscope operating with ImageJ software. Pores were thus identified by light transmission through the fabric, and the operating software functioned by generating a line across each identified pore to garner a pore diameter or average distance across the pore. Averages of multiple measurements were reported.

Tensile strength was evaluated according to ASTM 5035. Air permeability was evaluated according to ASTM D737. Thickness was measured according to ASTM D1777. In sample 1, point bond calendaring led to a fabric having an overall average pore size as shown in Table 7; however, a portion of the pores were distinctly larger and were in the range of about 500 microns. As such, the ratio of particle size to pore size was an overall average of about 8; however, if measuring based on the 500 micron pores that were present, the ratio was about 1.6.

TABLE 7

| Property | Sample 1 | Sample 2 | Sample 3 | Sample 4 | Sample 5 | Sample 6 |
|---|---|---|---|---|---|---|
| Basis weight | 60 | 130 | 262 | 180 | 30 | 100 |
| Density (g/cc) | 0.16 | 0.07 | 0.36 | 0.088 | 0.105 | 0.29 |
| Release on Tumbling (%) | 0.55 | 0.0003 | 0.0047 | 0.0004 | 0.042 | 0.53 |
| Ratio of particle size to | 8 | 16 | 8 | 16 | 16 | 1.6 |
| pore size | | | | | | |
| Avg. pore size (microns) | 100 | 50 | 100 | 50 | 50 | 500 |
| Tensile strength MD (N) | 12.90 | 118.32 | 86.29 | 71.17 | 17.35 | 137 |
| Tensile strength CD (N) | 2.22 | 42.26 | 51.60 | 14.23 | NA | 56.49 |
| Air Permeability | 341.5 | 236.7 | 25 | 241.8 | NA | 488.4 |
| (Ft³/Ft²/min) | | | | | | |
| Thickness (mm) | 0.38 | 1.77 | 0.726 | 2.04 | 0.287 | 0.35 |

### Example 7—Detergent Formulation Granulation

A standard, powdered laundry detergent having a composition as generally described above was blended with PEG having a molecular weight range from 1000 to 20,000 Daltons. The PEG was used in an amount of 35% to 95% of the overall formulation, with the balance being the detergent. The PEG was melted in a TOAUTO 6.5 Liter Wax Melter at temperatures between 35° C. and 110° C. The molten PEG was measured out to the weight percent required and added to a pre-heated Artestia Electric Fondue 1500W Maker configured for double boiler mode. The detergent was then added to the molten PEG and blended together with any heat-safe utensil to achieve substantial uniformity. The uniform mixture was measured out into molds and allowed to sit at room temperature to solidify into tablets. The solidified tablets were ground in a Quadro 194 Overdriven Conical Comil using a 2C156Q screen attached. The speed of the Comil was adjusted between 700 and 2400 RPM using a variable frequency drive provided by the manufacturer on the Quadro 194. Speed and screens can be varied to adjust granule size. Specifically, using a constant speed setting, the particle size of the granule can be reduced as the number of holes per inch increases. Depending upon the formulation, the solidified PEG/detergent tablets will be reduced to granules at lower holes per inch settings or a powder at a higher holes per inch settings. Once the matrix was processed through the Comil, screening using Ro-Tap screens to obtain the desired particle size distribution cut was performed.

### Example 8—Cleaning Efficacy of Granulated Detergent

Testing was carried out to evaluate additive cleaning effects of a granulation aid (PEG 8000) when blended with a typical detergent composition (as described above) to form a detergent formulation according to the present disclosure. Cotton or polycotton fabrics were soiled with different staining and soiling agents and were then subjected to identical laundering steps using the typical detergent composition alone or the typical detergent composition blended with PEG 800 as a granulation aid (20% by weight PEG and 80% by weight detergent). Laundry Wash Performance Testing was performed following ASTM D4265 Standard Guide for Evaluating Stain Removal Performance in Home Laundering. As seen in Table 8 below, laundry detergent formulation prepared using PEG 8000 as a granulation aid provided higher removal of several stains/soils from cotton and polycotton as compared to the laundry detergent without the PEG 8000 granulation aid.

TABLE 8

| | | Stain Removal Index (SRI) of | |
|---|---|---|---|
| | | the Laundry Detergent | |
| Staining or Soiling Agent | Fabric | Detergent Alone | Detergent/PEG |
| Grass | Cotton | 17.4 | 20.6 |
| Spaghetti sauce | Polycotton | 88.8 | 89.5 |
| Gravy | Cotton | 38.1 | 41.8 |
| Gravy | Polycotton | 64.2 | 65.2 |
| EMPA 101 (carbon black | Cotton | 10.0 | 10.5 |
| and olive oil) | | | |
| EMPA 101 (carbon black | Polycotton | 11.5 | 12.6 |
| and olive oil) | | | |
| Clay | Cotton | 46.8 | 50.7 |
| Clay | Polycotton | 68.1 | 71.3 |
| Meat drippings with carbon | Cotton | 39.2 | 40.8 |
| black | | | |
| Beef tallow and pork lard | Cotton | 33.4 | 38.3 |
| with carbon black | | | |

| | | |
|---|---|---|
| Totals | 417.5 | 441.3 |

### Example 9—Dissolution of Detergent Articles

Testing was carried out to evaluate the ability of detergent articles to dissolve in washing water and thus avoid the presence of residual particles from the detergent or the carrier material in the water. A test article according to the present disclosure was evaluated against four comparative articles where a detergent composition was combined with a carrier (e.g., inside of a dissolvable pouch or embedded in a dissolvable sheet or bar. The test article was formed of a detergent formulation prepared using a typical detergent composition combined with PEG 8000 as a granulation aid. The detergent formulation of the test article was placed inside of a nonwoven fabric formed of fibers made of 100% PVOH, the nonwoven being calendar bonded to provide a fabric with a basis weight of 60 gsm.

The test article and each of the four comparative articles were separately added to 1 L of deionized water at 15° C. and allowed to dissolve with constant stirring for 10 minutes. The resultant solutions were filtered through filter paper on a Buchner funnel under vacuum. Once residual solids from the separate solutions were gathered, the filter paper with the residual solids was placed in an oven at 54° C. for 10 minutes to drive off any remaining water. The filter papers were then weighed to determine the weight of residual particles from the solution (i.e., weight of paper with residue minus weight of the paper before addition of the residue).

Three of the four comparative articles resulted in a solution with a sufficiently high amount of undissolved solids that filtration by the Buchner funnel method was unsuccessful. The fourth comparative sample and the test sample each had a visual appearance of substantially complete dissolution, and both were successfully filtered. Residue for the two samples that were successfully filtered was calculated as the weight of residue captured on the filter paper divided by the original weight of the article prior to dissolution.

The comparative sample had a starting weight of 3.98 g, and 3.5 g of residue was captured by filtration. This indicated that 87.94% of the solid mass of the original article did not fully dissolve in the water.

The test sample according to the present disclosure had a starting weight of 31.11 g, and 2.95 g of residue was captured by filtration. This indicated that only 9.48% of the solid mass of the original article did not fully dissolve in the water. The testing thus supported the conclusion that the combination of a woven or nonwoven fabric pouch with a detergent formulation formed of a typical detergent composition that has been blended with a granulation aid as described herein results in a detergent article with improved dissolution properties in wash water.

The terms “about” or “substantially” as used herein can indicate that certain recited values or conditions are intended to be read as encompassing the expressly recited value or condition and also values that are relatively close thereto or conditions that are recognized as being relatively close thereto. For example, unless otherwise indicated herein, a value of “about” a certain number or “substantially” a certain value can indicate the specific number or value as well as numbers or values that vary therefrom (+ or −) 2% or less, or 1% or less. Similarly, unless otherwise indicated herein, a condition that substantially exists can indicate the condition is met exactly as described or claimed or is within typical manufacturing tolerances or would appear to meet the required condition upon casual observation even if not perfectly meeting the required condition. In some embodiments, the values or conditions may be defined as being express and, as such, the term “about” or “substantially” (and thus the noted variances) may be excluded from the express value. Where a plurality of possible lower end values and a plurality of possible upper end values are provided for a particular parameter, it is understood that all possible combinations of values inclusive of any of the lower end values and any of the upper end values are encompassed for describing the parameter.

Many modifications and other embodiments of the disclosure will come to mind to one skilled in the art to which this disclosure pertains having the benefit of the teachings presented in the foregoing description; and it will be apparent to those skilled in the art that variations and modifications of the present disclosure can be made without departing from the scope or spirit of the disclosure. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. An article comprising:
a solid formulation that is a blend of a polymer granulation aid and a detergent composition comprising at least a surfactant and a builder, the polymer granulation aid comprising at least about 20% by weight of the solid formulation based on the total weight of the solid formulation; and
a pouch enclosing the solid formulation, the pouch being configured as a woven or nonwoven fabric formed of water-soluble fibers.

2. The article of claim 1, wherein the polymer granulation aid is a melt-reversible polymer.

3. The article of claim 1, wherein the polymer granulation aid has a melting temperature of about 40° C. to about 80° C.

4. The article of claim 1, wherein the polymer granulation aid is a polyethylene glycol (PEG) material.

5. The article of claim 4, wherein the PEG material has an average molecular weight of about 1000 Da to about 25000 Da.

6. The article of claim 1, wherein the polymer granulation aid is an ethylene oxide (EO) propylene oxide (PO) copolymer.

7. The article of claim 1, wherein the solid formulation is in the form of a plurality of particles.

8. The article of claim 7, wherein the plurality of particles has an average particle size of about 80 microns or greater.

9. The article of claim 1, wherein the solid formulation is configured as a plurality of particles having an average particle size, wherein the woven or nonwoven fabric is configured to have a plurality of pores defining an average pore size, and wherein a ratio of the average particle size to the average pore size is about 1.6 or greater.

10. The article of claim 9, wherein the ratio of the average particle size to the average pore size is no more than 50.

11. The article of claim 10, wherein the ratio of the average particle size to the average pore size is about 6 to about 35.

12. The article of claim 1, wherein the water-soluble fibers include fibers selected from the group consisting of polyvinyl alcohol (PVOH), polyethylene oxide, methyl cellulose, polyacrylates, and mixtures thereof.

13. The article of claim 1, wherein the pouch is configured to have an air permeability of about 10 ft³/ft²/min.

14. The article of claim 1, wherein the pouch is configured to have an average pore size of about 350 microns or less.

15. The article of claim 1, wherein the pouch is configured to have an average pore size of at least 5 microns.

16. The article of claim 1, wherein the pouch is configured to have an average pore size of about 50 microns to about 350 microns.

17. The article of claim 1, wherein the pouch is configured to have a basis weight of about 5 gsm (grams per square meter) to about 150 gsm.

18. An article comprising:
a plurality of particles of a formulation that comprises a detergent composition combined with a melt-reversible polymer, the detergent composition comprising at least a surfactant and a builder, and the melt-reversible polymer comprising at least about 20% by weight of the formulation based on the total weight of the solid formulation; and
a pouch enclosing the plurality of particles, the pouch being configured as one or more sheets of a water-soluble polymer in a non-film configuration.

19. The article of claim 18, wherein one or more of the following conditions applies:
the melt-reversible polymer has a melting temperature of about 40° C. to about 80° C.;
the melt-reversible polymer comprises one or more of a polyethylene glycol (PEG) material and an ethylene oxide (EO) propylene oxide (PO) copolymer;
the plurality of particles has an average particle size that is greater than about 80 microns;
the one or more sheets of the water-soluble polymer are configured as a woven or nonwoven fabric formed of water-soluble fibers;
the pouch is formed of a material selected from the group consisting of polyvinyl alcohol (PVOH), polyethylene oxide, methyl cellulose, polyacrylates, and mixtures thereof.

20. A method of preparing a detergent formulation, the method comprising:
mixing a detergent composition comprising at least a surfactant and a builder with a melt-reversible polymer while the melt-reversible polymer is in a flowable condition to form a blend of the detergent composition and the melt-reversible polymer;
solidifying the formed blend; and
processing the formed blend through a granulator to configure the formed blend as a plurality of particles.
